(19) United States
(12) Patent Application Publication
(10) Pub. No.: US 2009/0097964 A1
(43) Pub. Date: Apr. 16, 2009

(54) WIND TURBINE WITH MIXERS AND EJECTORS

(76) Inventors: Walter M. Presz, JR., Wilbraham, MA (US); Michael J. Werle, West Hartford, CT (US)

Correspondence Address: Fay Sharpe LLP, 1228 Euclid Avenue, 5th Floor, The Halle Building, Cleveland, OH, 44115, US

(21) Appl. No.: 12/236,283

(22) Filed: Sep. 23, 2008

Related U.S. Application Data
(63) Continuation-in-part of application No. 12/054,050, filed on Mar. 24, 2008.
(60) Provisional application No. 60/919,588, filed on Mar. 23, 2007.

(51) Int. Cl. F03D 1/04; F03D 11/00

(52) U.S. Cl. 415/116; 415/220; 415/208.2

(57) ABSTRACT

A Mixer/Ejector Wind Turbine (“MEWT”) system is disclosed which routinely exceeds the efficiencies of prior wind turbines. In the preferred embodiment, Applicants' MEWT incorporates advanced flow mixing technology, ejector technology, aircraft and propulsion aerodynamics and noise abatement technologies in a unique manner to fluid-dynamically improve the operational effectiveness and efficiency of prior wind turbines, so that its operating efficiency routinely exceeds the Betz limit. Applicants' preferred MEWT embodiment comprises: a turbine shroud with a flared inlet; a ring of stator vanes; a ring of rotating blades (i.e., an impeller) in line with the stator vanes; and a mixer/ejector pump to increase the flow volume through the turbine while rapidly mixing the low energy turbine exit flow with high energy bypass wind flow. Unlike gas turbine mixers and ejectors which also mix with hot core exhaust gases, Applicants' preferred apparatus mixes only two air streams (i.e., wind): a primary air stream which rotates, and transfers energy to, the impeller while passing through the turbine; and a high energy bypass flow or “secondary” air stream which is entrained into the ejector, where the secondary air stream mixes with, and transfers energy to, the primary air stream. The MEWT can produce three or more time the power of its un-shrouded counterparts for the same frontal area, and can increase the productivity of wind farms by a factor of two or more. The same MEWT is safer and quieter providing improved wind turbine options for populated areas.

### RELATED APPLICATIONS

This application is a second continuation-in-part application of a co-pending Utility Application, Ser. No. 12/054,050, filed Mar. 24, 2008 (hereinafter “Applicants' Parent Application”), which claims priority from Applicants' U.S. Provisional Patent Application, Ser. No. 60/919,588, filed Mar. 23, 2007 (hereinafter “Applicants' Provisional Application”). Applicants hereby incorporate the disclosures of Applicants' Parent Application and Applicants' Provisional Application by reference in their entireties.

### FIELD OF INVENTION

The present invention deals generally with wind turbines. More particularly, it deals with apparatus for wind turbines.

### BACKGROUND OF INVENTION

Wind turbines usually contain a propeller-like device, termed the “rotor”, which is faced into a moving air stream. As the air hits the rotor, the air produces a force on the rotor in such a manner as to cause the rotor to rotate about its center. The rotor is connected to either an electricity generator or mechanical device through linkages such as gears, belts, chains or other means. Such turbines are used for generating electricity and powering batteries. They are also used to drive rotating pumps and/or moving machine parts. It is very common to find wind turbines in large electricity generating “wind farms” containing multiple such turbines in a geometric pattern designed to allow maximum power extraction with minimal impact of each such turbine on one another and/or the surrounding environment.

The ability of a rotor to convert fluid power to rotating power, when placed in a stream of very large width compared to its diameter, is limited by the well documented theoretical value of 59.3% of the oncoming stream's power, known as the “Betz” limit as documented by A. Betz in 1926. This productivity limit applies especially to the traditional multi-bladed axial wind/water turbine presented in FIG. 1A, labeled Prior Art.

Attempts have been made to try to increase wind turbine performance potential beyond the “Betz” limit. Shrouds or ducts surrounding the rotor have been used. See, e.g., U.S. Pat. No. 7,218,011 to Hiel et al. (see FIG. 1B); U.S. Pat. No. 4,204,799 to de Geus (see FIG. 1C); U.S. Pat. No. 4,075,500 to Oman et al. (see FIG. 1D); and U.S. Pat. No. 6,887,031 to Tocher. Properly designed shrouds cause the oncoming flow to speed up as it is concentrated into the center of the duct. In general, for a properly designed rotor, this increased flow speed causes more force on the rotor and subsequently higher levels of power extraction. Often though, the rotor blades break apart due to the shear and tensile forces involved with higher winds.

Values two times the Betz limit allegedly have been recorded but not sustained. See Igar, O., Shrouds for Aerogenerators, AIAA Journal, October 1976, pp. 1481-83; Igar & Ozer, Research and Development for Shrouded Wind Turbines, Energy Cons. & Management, Vol. 21, pp. 13-48, 1981; and see the AIAA Technical Note, entitled “Ducted Wind/Water Turbines and Propellers Revisited”, authored by Applicants (“Applicants' AIAA Technical Note”), and accepted for publication. Copies can be found in Applicants' Information Disclosure Statement. Such claims however have not been sustained in practice and existing test results have not confirmed the feasibility of such gains in real wind turbine application.

To achieve such increased power and efficiency, it is necessary to closely coordinate the aerodynamic designs of the shroud and rotor with the sometimes highly variable incoming fluid stream velocity levels. Such aerodynamic design considerations also play a significant role on the subsequent impact of flow turbines on their surroundings, and the productivity level of wind farm designs.

Ejectors are well known and documented fluid jet pumps that draw flow into a system and thereby increase the flow rate through that system. Mixer/ejectors are short compact versions of such jet pumps that are relatively insensitive to incoming flow conditions and have been used extensively in high speed jet propulsion applications involving flow velocities near or above the speed of sound. See, for example, U.S. Pat. No. 5,761,900 by Dr. Walter M. Presz, Jr, which also uses a mixer downstream to increase thrust while reducing noise from the discharge. Dr. Presz is a co-inventor in the present application.

Gas turbine technology has yet to be applied successfully to axial flow wind turbines. There are multiple reasons for this shortcoming. Existing wind turbines commonly use non-shrouded turbine blades to extract the wind energy. As a result, a significant amount of the flow approaching the wind turbine blades flows around and not through the blades. Also, the air velocity decreases significantly as it approaches existing wind turbines. Both of these effects result in low flow through, turbine velocities. These low velocities minimize the potential benefits of gas turbine technology such as stator/rotor concepts. Previous shrouded wind turbine approaches have keyed on exit diffusers to increase turbine blade velocities. Diffusers require long lengths for good performance, and tend to be very sensitive to oncoming flow variations. Such long, flow sensitive diffusers are not practical in wind turbine installations. Short diffusers stall, and just do not work in real applications. Also, the downstream diffusion needed may not be possible with the turbine energy extraction desired at the accelerated velocities. These effects have doomed all previous attempts at more efficient wind turbines using gas turbine technology.

Accordingly, it is a primary object of the present invention to provide an improved apparatus that employs advanced fluid dynamic mixer/ejector pump principles in a wind turbine to consistently deliver sustainable levels of power well above the Betz limit.

It is another primary object to provide an improved method for an axial flow wind turbine that employs unique flow mixing (for wind turbines) to increase productivity of and minimize the impact of its attendant flow field on the surrounding environment located in its near vicinity, such as found in wind farms.

It is another primary object to provide an improved apparatus that creates more flow through an axial flow wind turbine's rotor and then rapidly mixes lower energy exit flow with higher energy bypass wind flow before exiting the turbine.

It is another primary object to provide an improved wind turbine that employs unique flow mixing (for wind turbines) and control devices to increase productivity of and minimize the impact of its attendant flow field on the surrounding environment located in its near vicinity, such as found in wind farms.

It is another primary object to provide an improved wind turbine that pumps in more air flow through the rotor and then rapidly mixes the low energy turbine exit flow with high energy bypass wind flow before exiting the system.

It is a more specific object, commensurate with the above-listed objects, to provide a method and apparatus which are relatively quiet and safe to use in populated areas.

### SUMMARY OF INVENTION

A method and apparatus are disclosed for improving the sustainable efficiency of wind turbines beyond the Betz limit. Both the method and apparatus use fluid dynamic ejector concepts and advanced flow mixing to increase the operational efficiency, while lowering the noise level, of Applicant's unique wind turbine compared to existing wind turbines.

Applicant's preferred apparatus is a mixer/ejector wind turbine (nicknamed “MEWT”). In the preferred “apparatus” embodiment, the MEWT is an axial flow turbine comprising, in order going downstream: a turbine shroud having a flared inlet; a ring of stators within the shroud; an impeller having a ring of impeller blades “in line” with the stators; a mixer, attached to the turbine shroud, having a ring of mixing lobes extending downstream beyond the impeller blades; and an ejector comprising the ring of mixing lobes (e.g., like that shown in U.S. Pat. No. 5,761,900) and a mixing shroud extending downstream beyond the mixing lobes. The turbine shroud, mixer and ejector are designed and arranged to draw the maximum amount of fluid through the turbine and to minimize impact to the environment (e.g., noise) and other power turbines in its wake (e.g., structural or productivity losses). Unlike the prior art, the preferred MEWT contains a shroud with advanced flow mixing and control devices such as lobed or slotted mixers and/or one or more ejector pumps. The mixer/ejector pump presented is much different than used in the aircraft industry since the high energy air flows into the ejector inlets, and outwardly surrounds, pumps and mixes with the low energy air exiting the turbine shroud.

In this first preferred “apparatus” embodiment, the MEWT broadly comprises: an axial flow wind turbine surrounded by a turbine shroud, with a flared inlet, incorporating mixing devices in its terminus region (i.e., an end portion of the turbine shroud) and a separate ejector duct overlapping but aft of said turbine shroud, which itself may incorporate advanced mixing devices in its terminus region.

In an alternate “apparatus” embodiment, the MEWT comprises: an axial flow wind turbine surrounded by an aerodynamically contoured turbine shroud incorporating mixing devices in its terminus region.

In a broad sense, the preferred method comprises: generating a level of power over the Betz limit for a wind turbine (preferably an axial flow wind turbine), of the type having a turbine shroud with a flared inlet and an impeller downstream having a ring of impeller blades, by receiving and directing a primary air stream of ambient air into a turbine shroud; rotating the impeller inside the shroud by the primary air stream, whereby the primary air stream transfers energy to the impeller; and, entraining and mixing a secondary air stream of ambient air exclusively with the primary air stream, which has passed the impeller, via a mixer and an ejector sequentially downstream of the impeller.

An alternate method comprises: generating a level of power over the Betz limit for a wind mill, having a turbine shroud with a flared inlet and an propeller-like rotor downstream, by entraining and mixing ambient air exclusively with lower energy air, which has passed through the turbine shroud and rotor, via a mixer and an ejector sequentially downstream of the rotor.

First-principles-based theoretical analysis of the preferred method and apparatus indicates that the MEWT can produce three or more times the power of its un-shrouded counterparts for the same frontal area, and increase the productivity of wind farms by a factor of two or more.

Applicants believe, based upon their theoretical analysis, that the preferred method and apparatus will generate three times the existing power of the same size conventional wind turbine.

Other objects and advantages of the current invention will become more readily apparent when the following written description is read in conjunction with the accompanying drawings.

### BRIEF DESCRIPTION OF THE DRAWINGS

FIGS. 1A, 1B, 1C and 1D, labeled “Prior Art”, illustrate examples of prior turbines;

FIG. 2 is an exploded view of Applicants' preferred MEWT embodiment, constructed in accordance with the present invention;

FIG. 3 is a front perspective view of the preferred MEWT attached to a support tower;

FIG. 4 is a front perspective view of a preferred MEWT with portions broken away to show interior structure, such as a power takeoff in the form of a wheel-like structure attached to the impeller;

FIG. 5 is a front perspective view of just the stator, impeller, power takeoff, and support shaft from FIG. 4;

FIG. 6 is an alternate embodiment of the preferred MEWT with a mixer/ejector pump having mixer lobes on the terminus regions (i.e., an end portion) of the ejector shroud;

FIG. 7 is a side cross-sectional view of the MEWT of FIG. 6;

FIG. 8 is a close-up of a rotatable coupling (encircled in FIG. 7), for rotatably attaching the MEWT to a support tower, and a mechanical rotatable stator blade variation;

FIG. 9 is a front perspective view of an MEWT with a propeller-like rotor;

FIG. 10 is a rear perspective view of the MEWT of FIG. 9;

FIG. 11 shows a rear plan view of the MEWT of FIG. 9;

FIG. 12 is a cross-sectional view taken along sight line 12-12 of FIG. 11;

FIG. 13 is a front plan view of the MEWT of FIG. 9;

FIG. 14 is a side cross-sectional view, taken along sight line 14-14 of FIG. 13, showing two pivotable blockers for flow control;

FIG. 15 is a close-up of an encircled blocker in FIG. 14;

FIG. 16 illustrates an alternate embodiment of an MEWT with two optional pivoting wing-tabs for wind alignment;

FIG. 17 is a side cross-sectional view of the MEWT of FIG. 16;

FIG. 18 is a front plan view of an alternate embodiment of the MEWT incorporating a two-stage ejector with mixing devices (here, a ring of slots) in the terminus regions of the turbine shroud (here, mixing lobes) and the ejector shroud;

FIG. 19 is a side cross-sectional view of the MEWT of FIG. 18;

FIG. 20 is a rear view of the MEWT of FIG. 18;

FIG. 21 is a front perspective view of the MEWT of FIG. 18;

FIG. 22 is a front perspective view of an alternate embodiment of the MEWT incorporating a two-stage ejector with mixing lobes in the terminus regions of the turbine shroud and the ejector shroud;

FIG. 23 is a rear perspective view of the MEWT of FIG. 22;

FIG. 24 shows optional acoustic lining within the turbine shroud of FIG. 22;

FIG. 25 shows a MEWT with a noncircular shroud component; and

FIG. 26 shows an alternate embodiment of the preferred MEWT with mixer lobes on the terminus region (i.e., an end portion) of the turbine shroud.

### DETAILED DESCRIPTION OF PREFERRED EMBODIMENTS

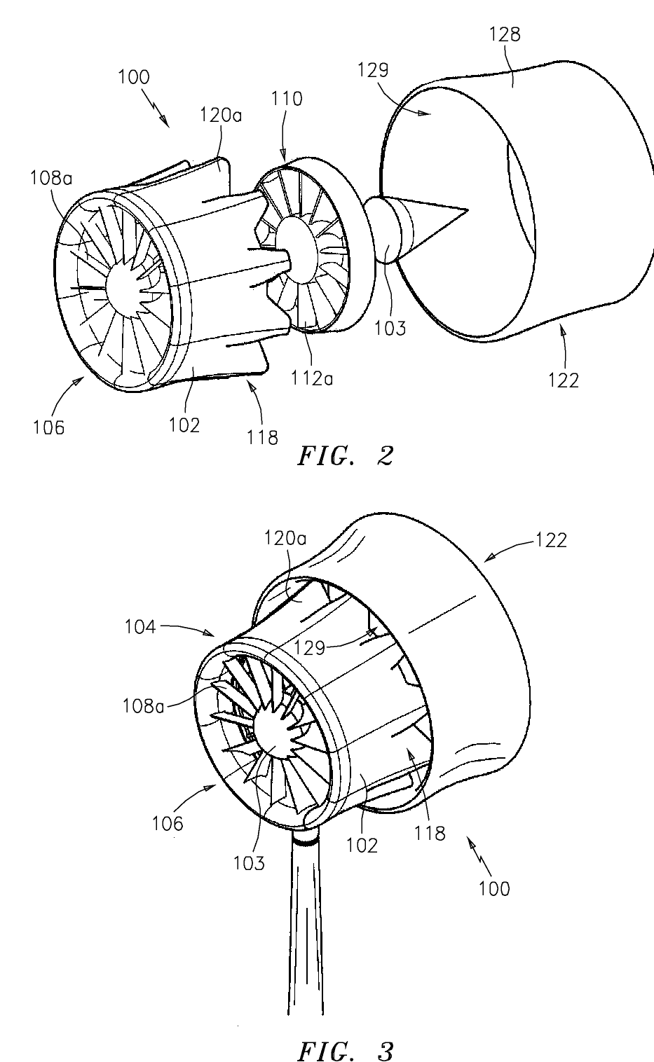

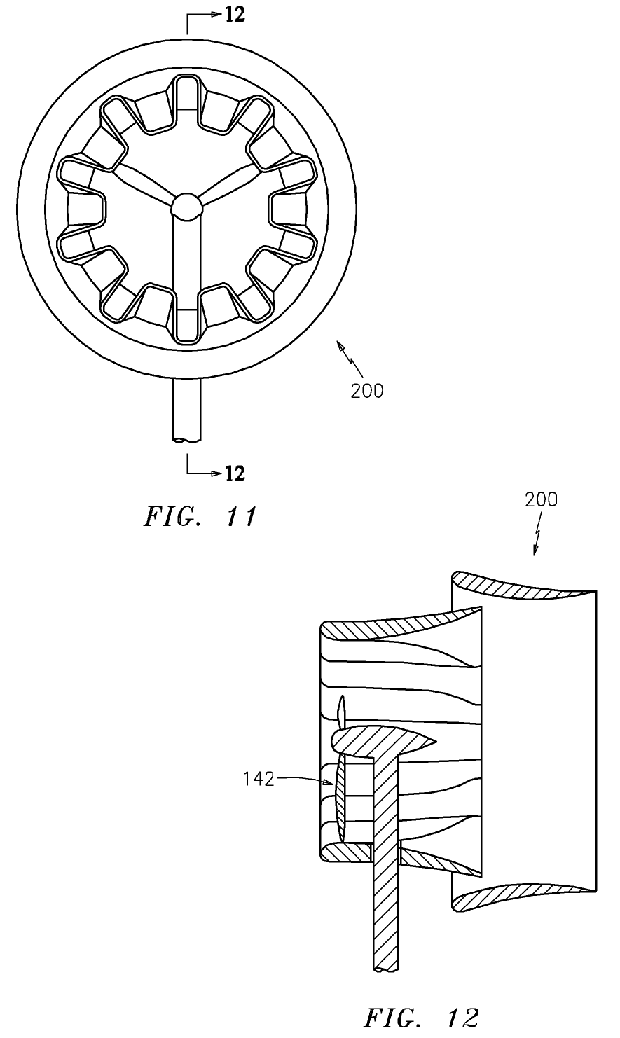

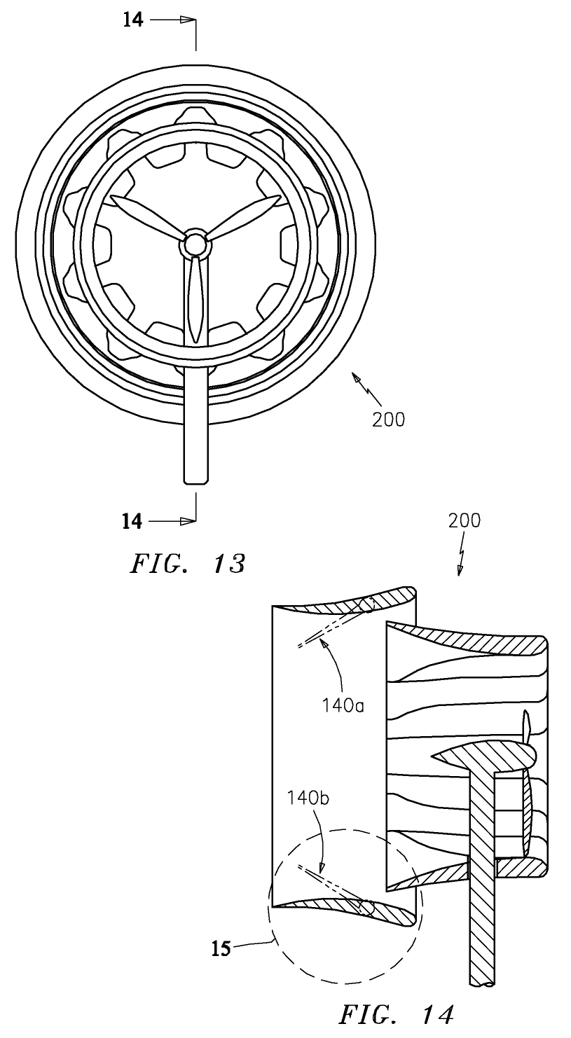

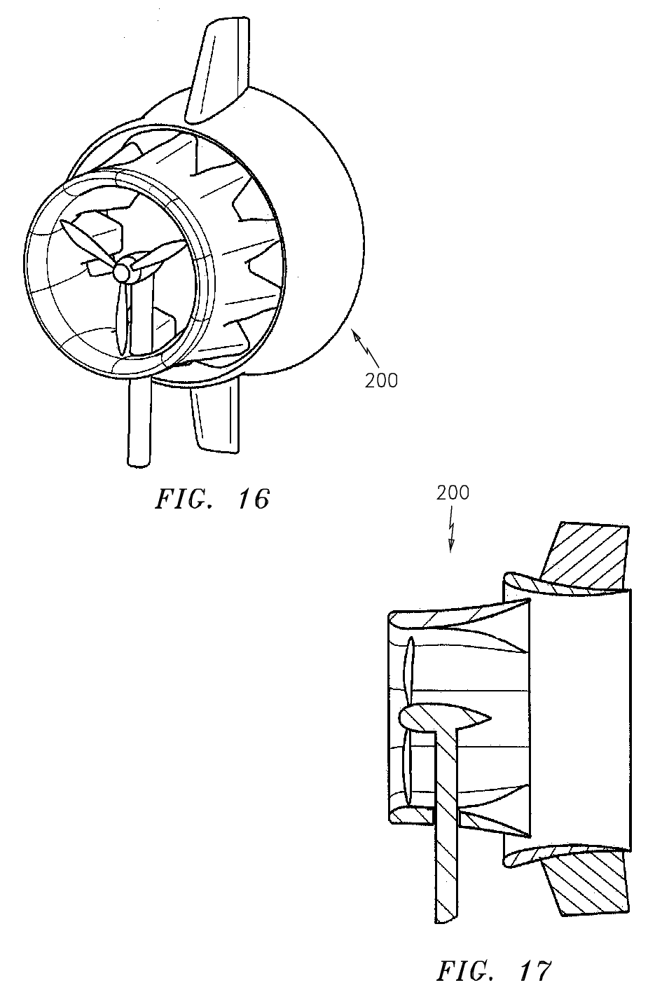

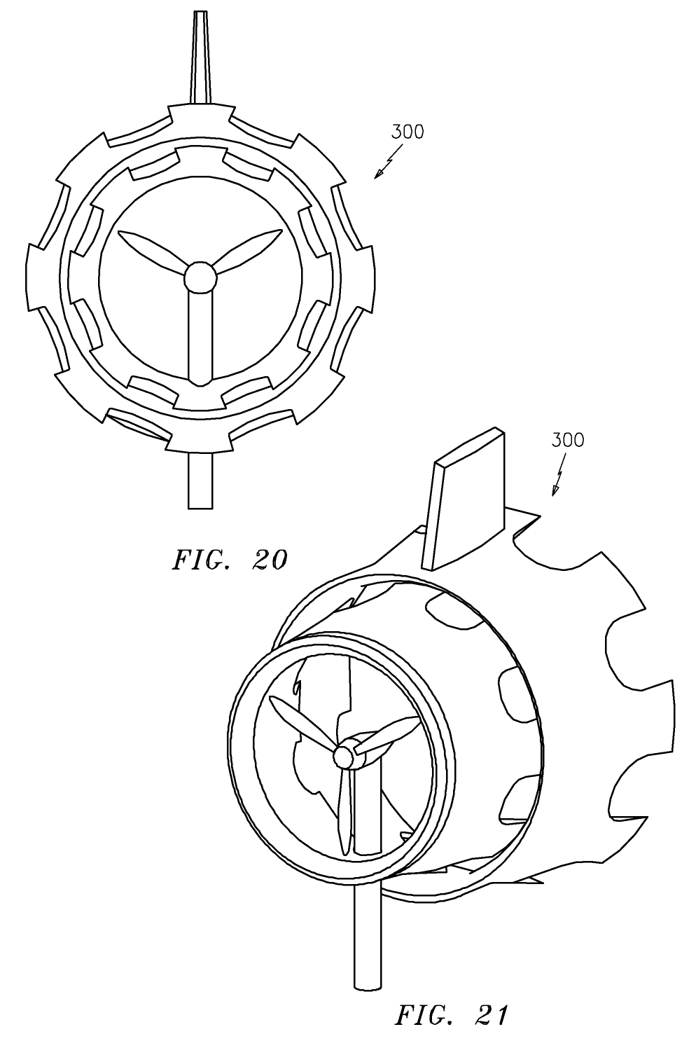

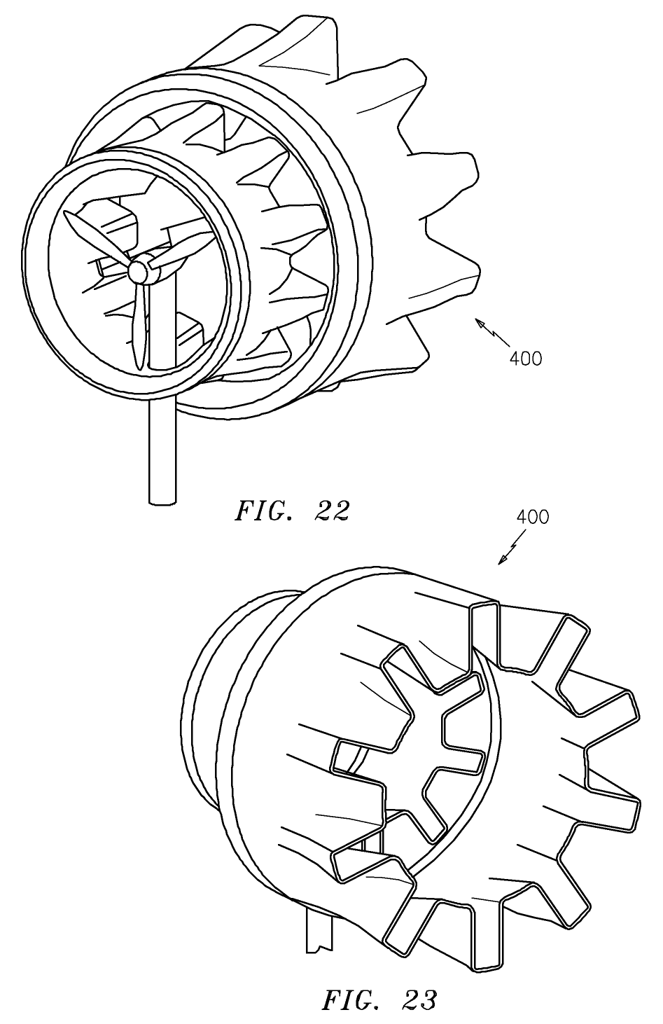

Referring to the drawings in detail, FIGS. 2-25 show alternate embodiments of Applicants' apparatus, “Wind Turbines with Mixers and Ejectors” (“MEWT”).

In the preferred “apparatus” embodiment (see FIGS. 2, 3, 4 and 5), the MEWT 100 is an axial flow wind turbine comprising:
a. an aerodynamically contoured turbine shroud 102;
b. an aerodynamically contoured center body 103 within and attached to the turbine shroud 102;
c. a turbine stage 104, surrounding the center body 103, comprising a stator ring 106 of stator vanes (e.g., 108a) and an impeller or rotor 110 having impeller or rotor blades (e.g., 112a) downstream and “in-line” with the stator vanes (i.e., leading edges of the impeller blades are substantially aligned with trailing edges of the stator vanes), in which:
   i. the stator vanes (e.g., 108a) are mounted on the center body 103; and
   ii. the impeller blades (e.g., 112a) are attached and held together by inner and outer rings or hoops mounted on the center body 103;
d. a mixer 118 having a ring of mixer lobes (e.g., 120a) on a terminus region (i.e., end portion) of the turbine shroud 102, wherein the mixer lobes (e.g., 120a) extend downstream beyond the impeller blades (e.g., 12a); and
e. an ejector 122 comprising a shroud 128, surrounding the ring of mixer lobes (e.g., 120a) on the turbine shroud, with a profile similar to the ejector lobes shown in U.S. Pat. No. 5,761,900, wherein the mixer lobes (e.g., 120a) extend downstream and into an inlet 129 of the ejector shroud 128.

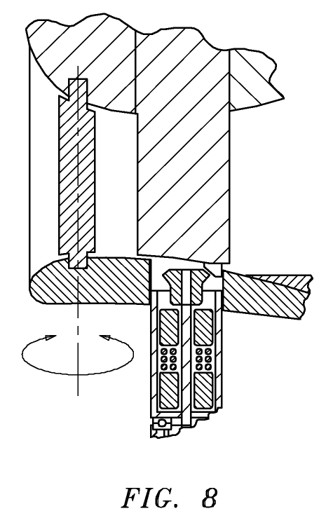

The center body 103 of MEWT 100, as shown in FIG. 7, is preferably connected to the turbine shroud 102 through the stator ring 106 (or other means) to eliminate the damaging, annoying and long distance propagating low-frequency sound produced by traditional wind turbines as the turbine's blade wakes strike the support tower. The aerodynamic profiles of the turbine shroud 102 and ejector shroud 128 preferably are aerodynamically cambered to increase flow through the turbine rotor.

Applicants have calculated, for optimum efficiency in the preferred embodiment 100, the area ratio of the ejector pump 122, as defined by the ejector shroud 128 exit area over the turbine shroud 102 exit area will be between 1.5 and 3.0. The number of mixer lobes (e.g., 120a) would be between 6 and 14. Each lobe will have inner and outer trailing edge angles between 5 and 25 degrees. The primary lobe exit location will be at, or near, the entrance location or inlet 129 of the ejector shroud 128. The height-to-width ratio of the lobe channels will be between 0.5 and 4.5. The mixer penetration will be between 50% and 80%. The center body 103 plug trailing edge angles will be thirty degrees or less. The length to diameter (L/D) of the overall MEWT 100 will be between 0.5 and 1.25.

First-principles-based theoretical analysis of the preferred MEWT 100, performed by Applicants, indicate: the MEWT can produce three or more times the power of its un-shrouded counterparts for the same frontal area; and the MEWT can increase the productivity of wind farms by a factor of two or more. See Applicants' AIAA Technical Note, identified in the Background above, for the methodology and formulae used in their theoretical analysis.

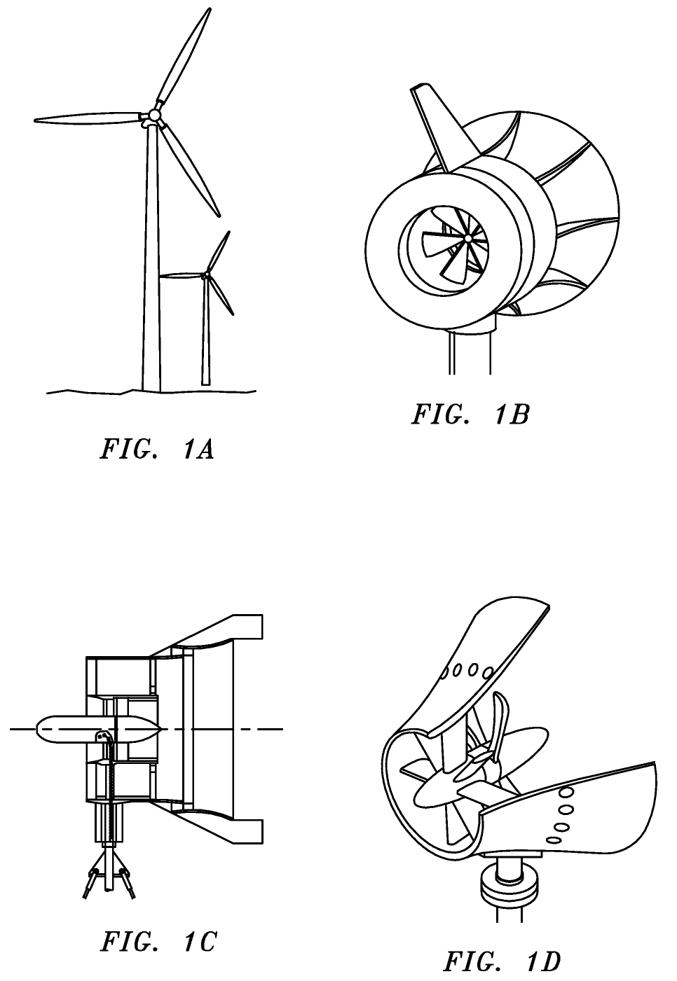

Based on their theoretical analysis, Applicants believe their preferred MEWT embodiment 100 will generate between at least two to three times the existing power of the same size conventional wind turbine (shown in FIG. 1A). Applicant's combined mixer and ejector draw into an associated turbine rotor two or three times the volume of air drawn into the rotors of traditional wind mills.

Traditional wind mills (a.k.a. wind turbines), with propeller-like rotors (see FIG. 1), convert wind into rotational and then electrical power. Such rotors can only displace, theoretically, a maximum of 59.3% of the oncoming stream's power. That 59.3% efficiency is known as the “Betz” limit, as described in the Background of this application.

Since their preferred method and apparatus increase the volume of air displaced by traditional wind turbines, with comparable frontal areas, by at least a factor of two or three, Applicants believe their preferred method and apparatus can sustain an operational efficiency beyond the Betz limit by a similar amount. Applicants believe their other embodiments also will exceed the Betz limit consistently, depending of course on sufficient winds.

In simplistic terms, the preferred “apparatus” embodiment 100 of the MEWT comprises: an axial flow turbine (e.g., stator vanes and impeller blades) surrounded by an aerodynamically contoured turbine shroud 102 (i.e., a shroud with a flared inlet) incorporating mixing devices in its terminus region (i.e., end portion); and a separate ejector shroud (e.g., 128) overlapping, but aft, of turbine shroud 102, which itself may incorporate advanced mixing devices (e.g., mixer lobes) in its terminus region. Applicants' ring 118 of mixer lobes (e.g., 120a) combined with the ejector shroud 128 can be thought of as a mixer/ejector pump. This mixer/ejector pump provides the means for consistently exceeding the Betz limit for operational efficiency of the wind turbine.

Applicants have also presented supplemental information for the preferred embodiment 100 of MEWT shown in FIGS. 2 and 3. It comprises a turbine stage 104 (i.e., with a stator ring 106 and an impeller 110) mounted on center body 103, surrounded by turbine shroud 102 with embedded mixer lobes (e.g., 120a) having trailing edges inserted slightly in the entrance plane of ejector shroud 128. The turbine stage 104 and ejector shroud 128 are structurally connected to the turbine shroud 102, which itself is the principal load carrying member.

The length of the turbine shroud 102 is equal or less than the turbine shroud's outer maximum diameter. The length of the ejector shroud 128 is equal to or less than the ejector shroud's outer maximum diameter. The exterior surface of the center body 103 is aerodynamically contoured to minimize the effects of flow separation downstream of the MEWT 100. It may be longer or shorter than the turbine shroud 102 or the ejector shroud 128, or their combined lengths.

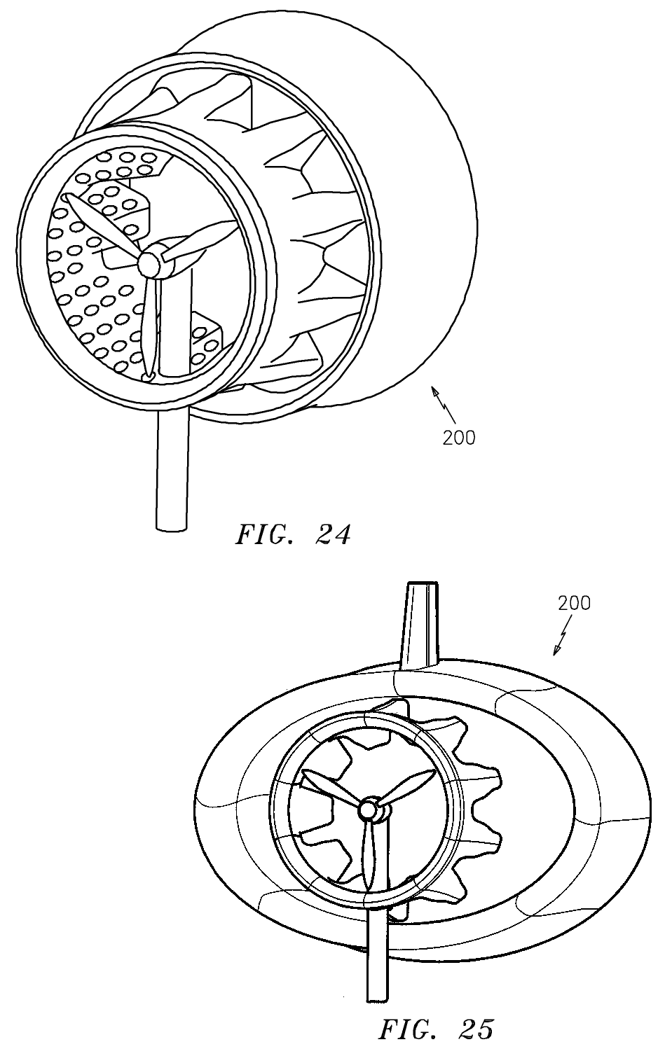

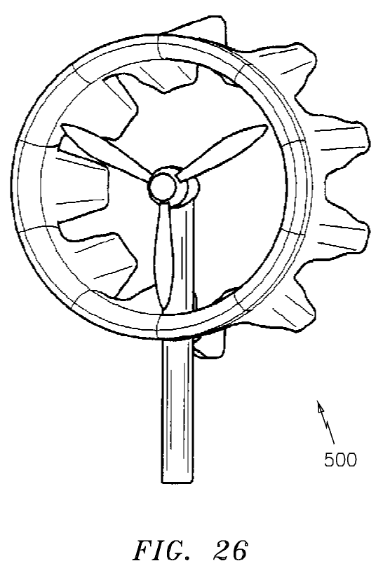

The turbine shroud's entrance area and exit area will be equal to or greater than that of the annulus occupied by the turbine stage 104, but need not be circular in shape so as to allow better control of the flow source and impact of its wake. The internal flow path cross-sectional area formed by the annulus between the center body 103 and the interior surface of the turbine shroud 102 is aerodynamically shaped to have a minimum area at the plane of the turbine and to otherwise vary smoothly from their respective entrance planes to their exit planes. The turbine and ejector shrouds' external surfaces are aerodynamically shaped to assist guiding the flow into the turbine shroud inlet, eliminating flow separation from their surfaces, and delivering smooth flow into the ejector entrance 129. The ejector 128 entrance area, which may be noncircular in shape (see, e.g., FIG. 25), is larger than the mixer 118 exit plane area and the ejector's exit area may also be noncircular in shape.

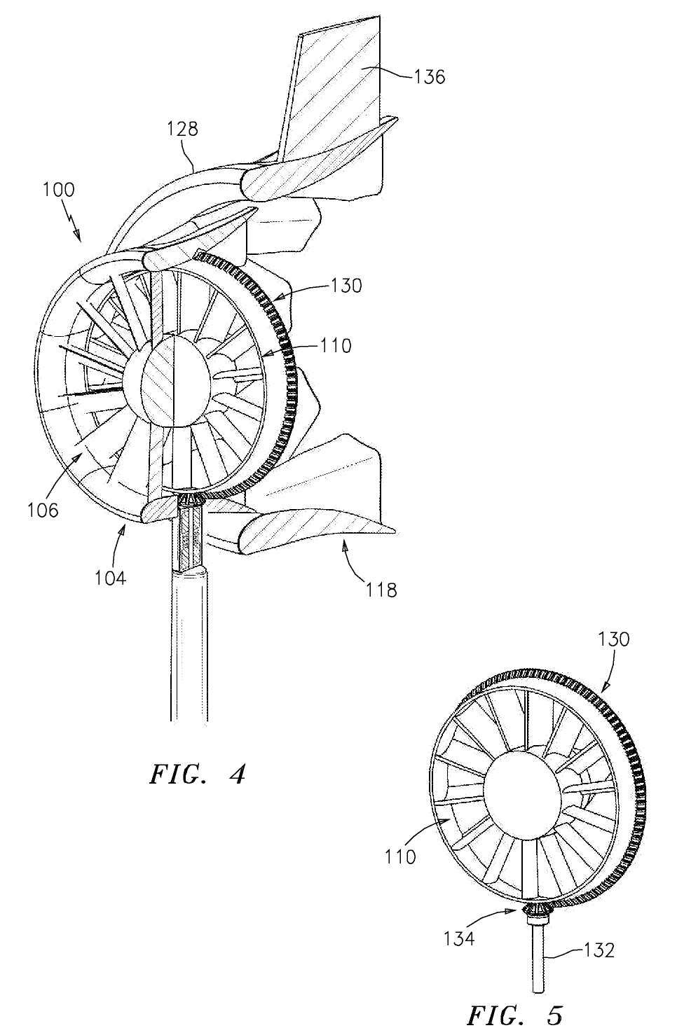

Optional features of the preferred embodiment 100 can include: a power take-off 130 (see FIGS. 4 and 5), in the form of a wheel-like structure, which is mechanically linked at an outer rim of the impeller 110 to a power generator (not shown); a vertical support shaft 132 with a rotatable coupling at 134 (see FIG. 5), for rotatably supporting the MEWT 100, which is located forward of the center-of-pressure location on the MEWT for self-aligning the MEWT; and a self-moving vertical stabilizer or “wing-tab” 136 (see FIG. 4), affixed to upper and lower surfaces of ejector shroud 128, to stabilize alignment directions with different wind streams.

MEWT 100, when used near residences, can have sound absorbing material affixed to the inner surface of its shrouds 102, 128 (see FIG. 24) to absorb and thus virtually eliminate the relatively high frequency sound waves produced by the interaction of the stator 106 wakes with the impeller 110. The METW can also contain safety blade containment structure (not shown).

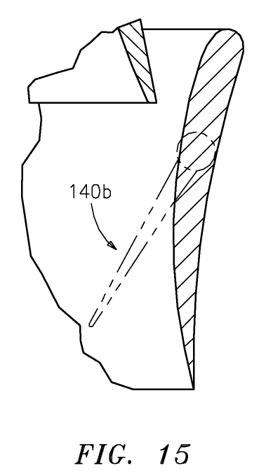

FIGS. 14 and 15 show optional flow blockage doors 140a, 140b. They can be rotated via linkage (not shown) into the flow stream to reduce or stop flow through the turbine 100 when damage, to the generator or other components, due to high flow velocity is possible.

FIG. 8 presents another optional variation of Applicants' preferred MEWT 100. The stator vanes' exit-angle incidence is mechanically varied in situ (i.e., the vanes are pivoted) to accommodate variations in the fluid stream velocity so as to assure minimum residual swirl in the flow exiting the rotor.

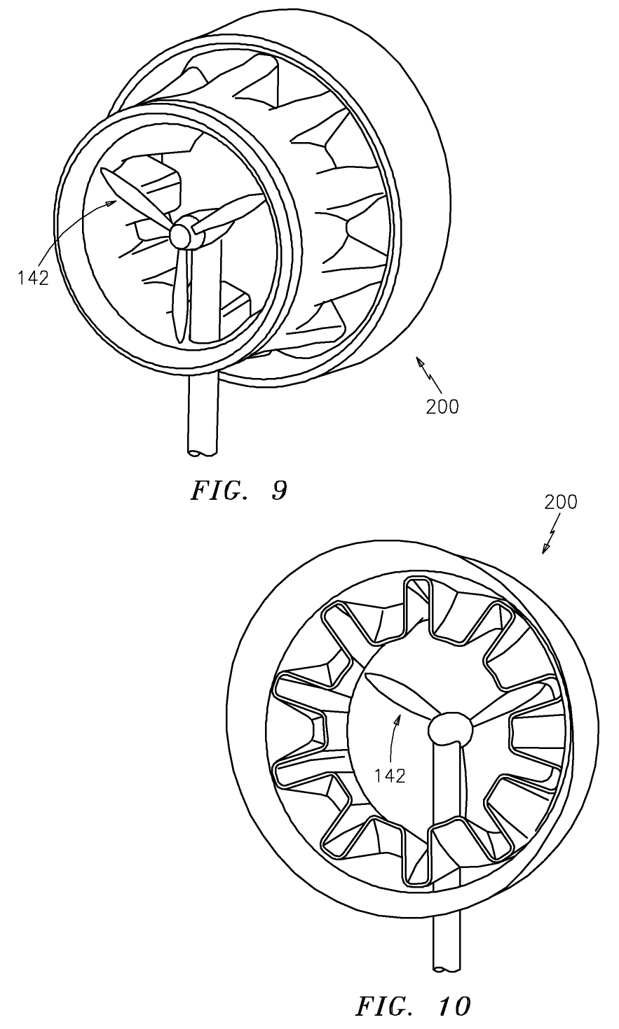

Note that Applicants' alternate MEWT embodiments, shown in FIGS. 9-23 and 26, each use a propeller-like rotor (e.g., 142 in FIG. 9) rather than a turbine rotor with a ring of impeller blades. While perhaps not as efficient, these embodiments may be more acceptable to the public.

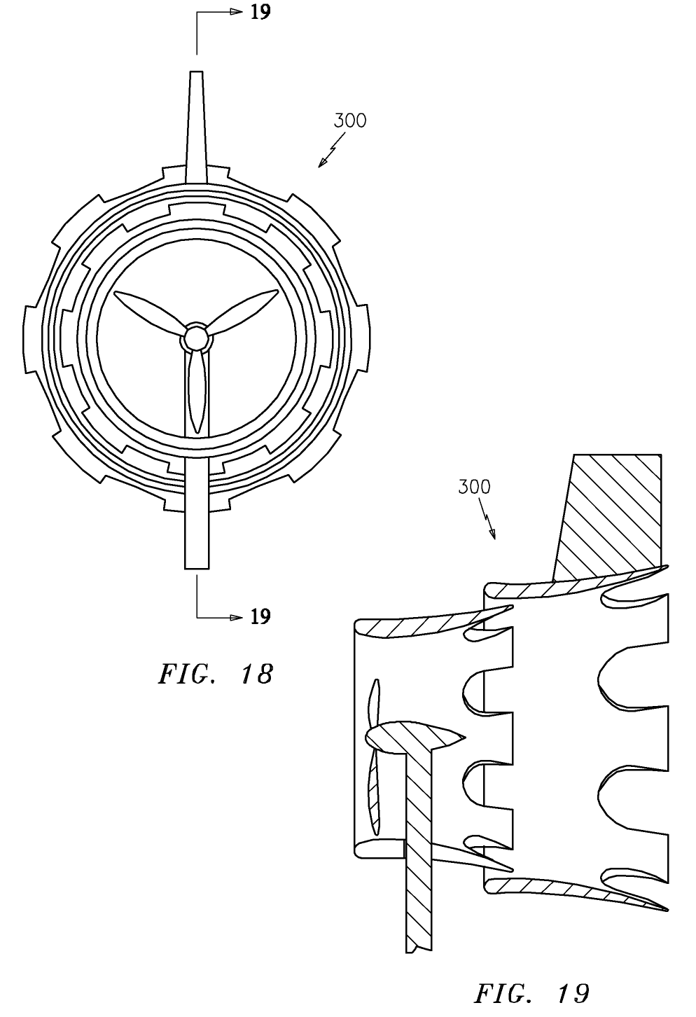

Applicants' alternate “apparatus” embodiments are variations 200, 300, 400, 500 containing zero (see, e.g., FIG. 26), one- and two-stage ejectors with mixers embedded in the terminus regions (i.e., end portions) of the ejector shrouds, if any. See, e.g., FIGS. 18, 20 and 22 for mixers (e.g., nozzles or slots) embedded in the terminus regions of the ejector shrouds. Tertiary air streams (of ambient air), which have not entered previously either the turbine shrouds or the ejectors, enter the mixers of the second-stage ejectors to mix with, and transfer energy to, the vortices of primary and secondary air streams exiting the terminus regions. Analysis indicates such MEWT embodiments will more quickly eliminate the inherent velocity defect occurring in the wake of existing wind turbines and thus reduce the separation distance required in a wind farm to avoid structural damage and/or loss of productivity.

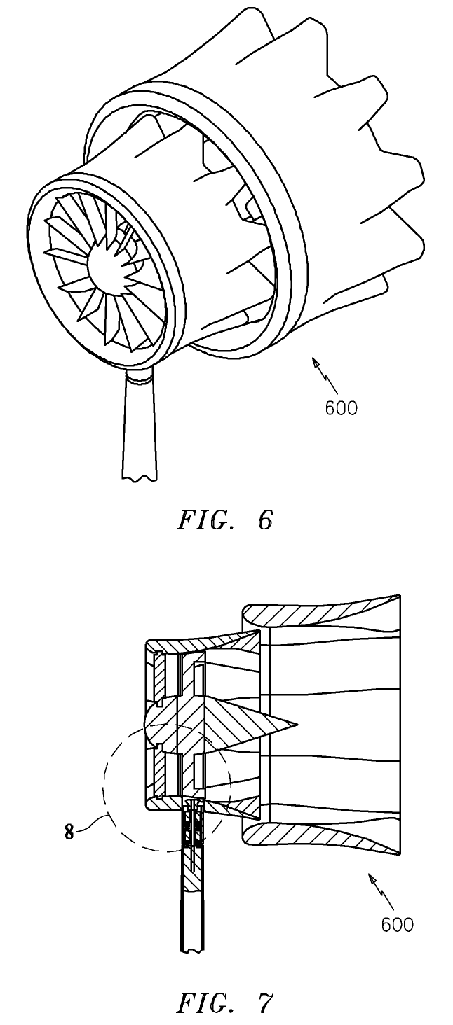

FIG. 6 shows a “two-stage” ejector variation 600 of the pictured embodiment 100 having a mixer at the terminus region of the ejector shroud.

The alternate “apparatus” embodiments 200, 300, 400, 500 in FIGS. 9-25 can be thought of broadly as comprising:
a. a wind mill, or wind turbine, having a shroud with a flared inlet;
b. a propeller-like rotor downstream of the inlet;
c. a mixer having a ring of mixer lobes which extend adjacent to and downstream of the rotor; and
d. an ejector surrounding trailing edges of the mixer lobes and extending downstream from the mixer lobes.

Each of Applicant's illustrated wind turbine shrouds is adapted in size and shape to produce a series of low loss mixing vortices, due to substantial non-uniformity of at least the turbine shroud, downstream of the impeller (a.k.a. rotor), when the wind turbine is exposed to a wind moving in the downstream direction.

Each turbine shroud has a wall which varies substantially in thickness along an axis of rotation of the impeller. So do the ejectors.

Applicants believe that even without an ejector (e.g., see FIG. 26), a mixer would still increase the volume of air entering into and displaced by Applicants' rotors, and hence increase the efficiency over prior wind turbines (whether shrouded or not) having comparable frontal areas. The increase, however, would be smaller than with an ejector.

Each embodiment of Applicant's wind turbine has an “upstream” direction and a “downstream” direction. By those terms, Applicant is referring to the position of each structural part relative to the direction of the incoming wind, when the turbine inlet is turned substantially into the wind.

Applicant's invention can be thought of in terms of methods. In a broad sense, the preferred method comprises:
a. generating a level of power over the Betz limit for a wind turbine (preferably an axial flow wind turbine), of the type having a turbine shroud with a flared inlet and an impeller downstream having a ring of impeller blades, by:
   i. receiving and directing a primary air stream of ambient air into a turbine shroud;
   ii. rotating the impeller inside the shroud by the primary air stream, whereby the primary air stream transfers energy to the impeller; and
   iii. entraining and mixing a secondary air stream of ambient air exclusively with the primary air stream, which has passed the impeller, via a mixer and an ejector sequentially downstream of the impeller.

An alternate method comprises:
a. generating a level of power over the Betz limit for a wind mill, having a turbine shroud with a flared inlet and an propeller-like rotor downstream, by:
   i. receiving and directing a primary air stream of ambient air into the flared inlet and through the turbine shroud;
   ii. rotating the impeller inside the shroud by the primary air stream, whereby the primary air stream transfers energy to the rotor and becomes a lower energy air stream; and
   iii. entraining and mixing a secondary stream of ambient air with the lower energy air stream via a mixer and an ejector sequentially downstream of the rotor.

Mixing the secondary air stream with the (lower energy) primary air stream inside the ejector: produces a series of mixing vortices due to substantial non-uniformity of at least the turbine shroud downstream of the impeller; and creates a transfer of energy from the secondary air stream to the primary stream.

Applicants' methods can also comprise:
a. directing the primary air stream, after rotating the impeller in the turbine shroud, away from a rotational axis of the impeller; and
b. directing the secondary air stream, after entering the ejector shroud, towards the impeller rotational axis.

While the preferred rotational axis of the impeller is illustrated as being coaxial with a central longitudinal axis of the shroud, the impeller's rotational axis need not be so for purposes of this method.

Unlike gas turbine mixers and ejectors which also mix with hot core exhaust gases, Applicants' preferred method(s) entrain and mix a secondary stream of ambient air (i.e., wind) exclusively with lower energy air (i.e., a partially spent primary stream of ambient air) which has passed through a turbine shroud and rotor.

Applicants believe that their preferred MEWT embodiments 100, 200, 300, 400 and 600, and Applicants' preferred and alternate methods described directly above, can consistently sustain, with sufficient winds, operational efficiencies beyond the Betz limit for days, weeks and years without any significant damage to the turbine.

In other words, Applicants believe their preferred MEWT embodiments 100, 200, 300, 400, and 600, and Applicants' preferred and alternate methods described directly above, can harness the power of the primary air stream to produce mechanical energy while exceeding the Betz limit for operational efficiency over a non-anomalous period.

Yet another broader, alternative method comprises:
a. increasing the volume of air flowing through a wind mill, of the type having a rotor, by:
   i. entraining and mixing ambient air exclusively with lower energy air, which has passed through the rotor, via a mixer adjacent to and downstream of the impeller.

This broader method can further include the steps of: increasing the volume of ambient air flowing through the wind mill, while minimizing the noise level of the discharge flow from the wind mill, by an ejector downstream of the mixer.

It should be understood by those skilled in the art that obvious modifications can be made without departing from the spirit or scope of the invention. For example, slots could be used instead of the mixer lobes or the ejector lobes. In addition, no blocker arm is needed to meet or exceed the Betz limit. Accordingly, reference should be made primarily to the appended claims rather than the foregoing description.

We claim:

1. An apparatus comprising:
a. a wind mill having a shroud with a flared inlet;
b. a propeller-like rotor downstream of the inlet;
c. a mixer having a ring of mixer lobes which extend downstream of the rotor; and
d. an ejector surrounding trailing edges of the mixer lobes and extending downstream from the mixer lobes.

2. An apparatus comprising:
a. a wind mill having a shroud with a flared inlet;
b. a rotor downstream of the inlet; and
c. a mixer extending downstream of the rotor.

3. The apparatus of claim 1 further comprises an ejector extending downstream from the mixer.

4. The apparatus of claim 1 wherein the mixer comprises a ring of mixer lobes which extend into the ejector.

5. The apparatus of claim 1 wherein the mixer comprises discrete mixer slots which extend into the ejector.

6. An apparatus comprising:
a. a wind mill having a shroud with a flared inlet;
b. a propeller-like rotor downstream of the inlet; and
c. means for generating a level of power over the Betz limit for a non-anomalous period by:
i. receiving and directing a primary air stream of ambient air into the flared inlet and through the turbine shroud;
ii. rotating the rotor inside the shroud by the primary air stream, whereby the primary air stream transfers energy to the rotor; and
iii. entraining and mixing a secondary air stream of ambient air exclusively with the primary air stream, which has passed through the rotor, via a mixer and an ejector sequentially downstream of the rotor, to transfer energy from the secondary air stream to the primary air stream and to create a series of vortices exiting the ejector.

7. The apparatus of claim 6 wherein the means further comprises:
a. the mixer having a ring of mixer lobes which extends downstream of the rotor; and
b. the ejector surrounding trailing edges of the mixer lobes and extending downstream from the mixer lobes.

8. The apparatus of claim 7 wherein the ejector is coaxial with the turbine shroud.

9. The apparatus of claim 7 wherein the ejector includes an ejector shroud concentric with an outlet of the turbine shroud.

10. A wind turbine, adapted to harness energy from a wind stream, comprising:
a. the wind turbine having an upstream direction and a downstream direction, relative to the wind stream, wherein the wind turbine includes:
b. a turbine shroud having an inlet and outlet;
c. an impeller having impeller blades, within the shroud, downstream of the inlet; and
d. an ejector shroud, coaxial with the turbine shroud, positioned adjacent to the outlet of the turbine shroud;
e. wherein the turbine shroud and the ejector shroud are adapted in size and shape to:
i. direct a primary air stream passing through an interior of the turbine shroud and through the impeller away from a rotational axis of the impeller; and
ii. direct a secondary air stream, which has not entered the turbine shroud, inside the ejector shroud and towards an impeller rotational axis.

11. The wind turbine of claim 11 wherein the turbine shroud, at its outlet, and the ejector are adapted in size and shape to mix the secondary air stream with the primary air stream downstream of the impeller.

12. The wind turbine of claim 11 wherein the turbine shroud, at its outlet, and the ejector are adapted in size and shape to transfer energy from the secondary air stream to the primary air stream more efficiently due to a formation of a series of mixing vortices downstream from the impeller.

13. The wind turbine of claim 11 wherein the turbine shroud and the ejector shroud, when so positioned, are adapted in size and shape to:
a. direct part of the secondary air stream into the ejector shroud and towards a location on the impeller rotational axis behind the outlet of the turbine shroud; and
b. direct part of the primary air stream through an interior of the turbine shroud and through the impeller away from the location on the rotational axis behind the outlet of the turbine shroud.

14. An apparatus comprising:
a. a wind turbine having an upstream direction and a downstream direction, the wind turbine including:
i. a turbine shroud having an inlet;
ii. an impeller downstream from the inlet of the turbine shroud;
iii. an ejector shroud positioned proximate to an outlet of the turbine shroud; and
iv. wherein the wind turbine shroud is adapted in size and shape to produce a series of low loss mixing vortices, due to substantial non-uniformity of at least the turbine shroud, downstream of the impeller, when the wind turbine is exposed to a wind moving in the downstream direction.

15. An apparatus comprising:
a. an axial flow wind turbine having an upstream direction and a downstream direction, the wind turbine including:
i. an impeller;
ii. mixer lobes;
iii. an ejector extending downstream from the mixer;
iv. the mixer lobes are positioned adjacent to an inlet of the ejector; and
v. wherein the wind turbine is adapted in size and shape to operate as a mixer/ejector pump due to the positioning of the mixer lobes relative to the ejector such that ambient air and lower energy air, relative to one another, mix to enhance airflow through the turbine stage.

16. An apparatus comprising:
a. an axial flow wind turbine having an upstream direction and a downstream direction, including:
i. stator vanes;
ii. an impeller downstream of the stator vanes;
iii. a mixer downstream of the impeller; and
iv. an ejector extending downstream from the mixer;
v. wherein the wind turbine is adapted to harness wind power to produce mechanical energy while exceeding the Betz limit for operational efficiency of the axial flow wind turbine.

17. The apparatus of claim 16 wherein the wind turbine is adapted in size and shape to harness wind power to produce mechanical energy while exceeding the Betz limit for operational efficiency of the axial flow wind turbine over a non-anomalous period.

18. The apparatus of claim 16 wherein the wind turbine is adapted in size and shape to harness wind power to produce mechanical energy while exceeding the Betz limit for operational efficiency of the axial flow wind turbine over a sustained period.

19. The apparatus of claim 16 wherein the wind turbine is adapted in size and shape to harness wind power to produce mechanical energy while consistently exceeding the Betz limit for operational efficiency of the axial flow wind turbine.

20. An apparatus comprising:
a. a wind turbine having an upstream direction and a downstream direction, including:
i. a turbine shroud with an inlet, a wall of the turbine shroud varying substantially in thickness along an axis of rotation of the impeller;
ii. an impeller located within the turbine shroud;
iii. flow mixing elements adjacent an exit plane of the turbine shroud exit; and
iv. an ejector positioned proximate to edges of the mixer elements and extending away from the mixer elements.

21. The apparatus of claim 20 wherein the wall of the turbine shroud that varies substantially in thickness along the axis of rotation of the impeller has a cambered shape.

22. The apparatus of claim 20 wherein a wall of the ejector varies substantially in thickness along an axis of rotation of the impeller.

23. The apparatus of claim 20 wherein the wall of the ejector that varies substantially in thickness along the axis of rotation of the impeller has a cambered shape.

24. An apparatus comprising:
a. a wind turbine having an upstream direction and a downstream direction, the wind turbine including:
i. an aerodynamically contoured turbine shroud with an inlet;
ii. an impeller having impeller blades positioned downstream of the inlet;
iii. a ring of mixer lobes, wherein the mixer lobes extend downstream of the impeller; and
iv. an ejector shroud surrounding the ring of mixer lobes, wherein the mixer lobes extend downstream and into the ejector shroud.

25. The apparatus of claim 24 wherein a second ring of mixer lobes is located at a terminus end of the ejector shroud.

26. The apparatus of claim 24 wherein an exterior surface of the wind turbine includes a self-adjusting movable wing-tab adapted to aerodynamically assist alignment of the wind turbine with an oncoming flow direction of wind.

27. An axial flow wind turbine comprising:
a. an aerodynamically contoured turbine shroud with an inlet and outlet; and
b. an impeller rotatably positioned within the turbine shroud; and:
c. means for sustainably exceeding the operational efficiency of the axial flow wind turbine over the Betz limit comprising:
i. a ring of mixer lobes, wherein the lobes extend downstream of the impeller and
ii. an ejector shroud surrounding the ring of mixer lobes, wherein the mixer lobes extend into the ejector shroud.

28. An apparatus comprising:
a. an axial flow wind turbine having an upstream direction and a downstream direction, the wind turbine including:
i. an aerodynamically contoured turbine shroud with an inlet;
ii. a turbine stage, mounted within the shroud, comprising:
iii. an impeller;
iv. a ring of mixer lobes, wherein the mixer lobes extend away from the impeller; and
v. an ejector surrounding trailing edges, relative to the impeller, of the mixer lobes and extending downstream from the mixer lobes.

29. An apparatus comprising:
a. an axial flow wind turbine having an upstream direction and a downstream direction, the wind turbine including:
i. an aerodynamically contoured turbine shroud with an inlet;
ii. an impeller;
iii. a mixer located proximate to the shroud, having mixer lobes extending downstream of the impeller; and
iv. an ejector extending downstream from the mixer lobes.

30. In an axial flow wind turbine is of the type having an upstream direction and a downstream direction, a turbine shroud with an inlet and a rotor, the improvement comprising a mixer having mixer lobes extending downstream of the rotor.

31. The apparatus of claim 31 wherein the mixer comprises a plurality of radially spaced mixer slots.

32. The apparatus of claim 31 further comprising an ejector extending downstream from the mixer.

33. The apparatus of claim 31 wherein the turbine further comprises a ring of stator blades upstream of impeller.

34. An apparatus comprising:
a. an axial flow wind turbine having an upstream direction and a downstream direction, the wind turbine including:
i. stator vanes;
ii. an impeller downstream of the stator vanes;
iii. a mixer downstream of the impeller;
iv. an ejector extending downstream from the mixer, and
v. another mixer embedded in a terminus region of the ejector;
vi. wherein the wind turbine is adapted in size and shape to harness wind power to produce mechanical energy while exceeding the Betz limit for operational efficiency of the axial flow wind turbine.

35. An axial flow wind turbine comprising:
a. a turbine shroud with an inlet and outlet; and
b. an impeller rotatably positioned within the turbine shroud; and
c. means for exceeding the operational efficiency of the axial flow wind turbine over the Betz limit comprising:
i. a ring of mixer lobes, wherein the lobes are embedded in the turbine shroud and extend downstream of the impeller;
ii. an ejector shroud surrounding the ring of mixer lobes, wherein the mixer lobes extend into the ejector shroud; and
iii. another ring of mixer lobes embedded in a terminus region of the ejector shroud.

36. A wind mill comprising:
a. a turbine shroud with an inlet and outlet; and
b. a propeller-like rotor positioned within the turbine shroud; and
c. means for exceeding the operational efficiency of the wind mill over the Betz limit comprising:
i. a ring of mixer lobes, wherein the lobes extend downstream of the rotor;
ii. an ejector shroud surrounding the ring of mixer lobes, wherein the mixer lobes extend into the ejector shroud; and
iii. another ring of mixer lobes embedded in a terminus region of the ejector.

37. An axial flow wind turbine comprising:
i. an impeller;
ii. a first mixer downstream of the impeller;
iii. an ejector adjacent to and extending downstream from the mixer, and
iv. a second mixer embedded in a terminus region of the ejector.
